(19) United States
(12) Patent Application Publication
(10) Pub. No.: US 2014/0269167 A1
(43) Pub. Date: Sep. 18, 2014

(54) CONFIGURABLE SOURCE ENCODERS FOR SEISMIC SYSTEMS

(71) Applicant: INOVA, LTD., Grand Cayman (KY)

(72) Inventors: Thomas F. Phillips, III, Edmond, OK (US); Timothy D. Hladik, Calgary (CA); Keith S. Radcliffe, Meadows Place, TX (US); Igor Samoylov, Stafford, TX (US); Bernard Maechler, Sugar Land, TX (US); Gerald H. Maguire, Calgary (CA)

(73) Assignee: INOVA, LTD., Grand Cayman (KY)

(21) Appl. No.: 14/208,681

(22) Filed: Mar. 13, 2014

Related U.S. Application Data
(60) Provisional application No. 61/783,613, filed on Mar. 14, 2013.
(60) Provisional application No. 61/783,856, filed on Mar. 14, 2013.
(60) Provisional application No. 61/784,024, filed on Mar. 14, 2013.

(51) Int. Cl. G01V 1/22

(52) U.S. Cl. CPC G01V 1/22
USPC 367/14

(57) ABSTRACT

A system for acquiring seismic information may include a seismic spread in signal communication with a central controller having a central recording system, a source encoder in signal communication with the seismic spread, and a source decoder in wireless signal communication with the source encoder. The source decoder and the encoder are each selectively responsive to a control signal and can be selectively configured to transmit the control signal.

### CROSS REFERENCE TO RELATED APPLICATIONS

This application claims priority from U.S. Provisional Patent Application Ser. Nos. 61/783,613, 61/783,856 and 61/784,024 which were filed on Mar. 14, 2013 and are fully incorporated herein by reference.

### BACKGROUND OF THE DISCLOSURE

1. Field of the Disclosure

This disclosure relates generally to systems and methods for conducting seismic data acquisition activities.

2. Background of the Art

Seismic surveys are conducted to map subsurface structures to identify and develop oil and gas reservoirs. Seismic surveys are typically performed to estimate the location and quantities of oil and gas fields prior to developing (drilling wells) the fields and also to determine the changes in the reservoir over time subsequent to the drilling of wells. On land, seismic surveys are conducted by deploying an array of seismic sensors (also referred to as seismic receivers) over selected geographical regions. The seismic sensors (geophones or accelerometers) are placed or coupled to the ground in the form of a grid. An energy source is used at selected predetermined locations (also referred to as source points) in the geographical area to generate or induce acoustic waves or signals (also referred to as acoustic energy) into the subsurface. The acoustic waves generated into the subsurface reflect back to the surface from subsurface formation discontinuities, such as those formed by oil and gas reservoirs. The reflections are sensed or detected at the surface by the seismic sensors and recorded. The sensing, processing and recording of the seismic waves is referred to as seismic data acquisition. Two-dimensional and/or three-dimensional maps of the subsurface structures (also referred to as the “seismic image”) are generated from the recorded seismic data. These maps are then used to make decisions about drilling locations, reservoir size, pay zone depth and estimates of the production of hydrocarbons.

The present disclosure provides methods and devices for facilitating seismic activity.

### SUMMARY OF THE DISCLOSURE

In aspects, the present disclosure provides a system for acquiring seismic information. The system may include a central controller, a seismic spread in signal communication with the central controller, one or more source encoders in signal communication with the seismic spread, and one or more source decoders in wireless signal communication with the source encoders. The source decoder(s) and the source encoder(s) are each selectively responsive to control signals. Further, the source decoder(s) and the source encoder(s) are selectively configured to transmit control signals.

In aspects, the present disclosure provides a method for acquiring seismic information. The method may include: positioning a central controller and a seismic spread in a geographical area of interest; forming a communication link between the seismic spread and the central controller; forming a communication link between at least one source encoder and the seismic spread; forming a wireless communication link between the at least one source encoder and at least one source decoder; controlling the at least one source decoder using a control signal sent from the at least one source encoder; configuring the at least one source decoder to send a second control signal after sending the control signal; configuring the at least one source encoder to be responsive to the second control signal after sending the control signal; and controlling the at least one source encoder using the second control signal sent from the at least one source decoder.

In aspects, the present disclosure provides a system for acquiring seismic information. The system may include a central controller and a seismic spread in signal communication with the central controller. The seismic spread may include a plurality of seismic devices configured for wireless signal communication; at least one source encoder in signal communication with at least one of the plurality of seismic devices; and at least one source decoder in signal communication with the at least one source encoder. The at least one source decoder is responsive to a signal transmitted by the at least one remote encoder.

In aspects, the present disclosure provides a method for acquiring seismic information. The method may include positioning a central controller and a seismic spread in a geographical area of interest, the seismic spread being in signal communication with the central controller, the seismic spread including: a plurality of seismic devices configured for wireless signal communication; at least one source encoder in signal communication with at least one of the plurality of seismic devices; and at least one source decoder in signal communication with the at least one source encoder, wherein the at least one source decoder is responsive to a signal transmitted by the at least one source encoder; and controlling the at least one remote encoder from the central controller, wherein the central controller instructs the at least one source encoder to transmit the signal to the source decoder.

In aspects, the present disclosure provides a system for acquiring seismic information. The system may include a central recording system (CRS) and a seismic spread. The seismic spread may include at least one cable in signal communication with the CRS, a plurality of seismic devices disposed along the at least one cable; at least one source encoder in signal communication with the at least one cable; and at least one source decoder in signal communication with the at least one source encoder. The at least one source decoder is responsive to a signal transmitted by the at least one remote encoder.

In aspects, the present disclosure provides a method for acquiring seismic information. The method may include the steps of positioning a central recording system (CRS) and a seismic spread in a geographical area of interest, the seismic spread including at least one cable in signal communication with the CRS, and a plurality of seismic devices disposed along the at least one cable; forming a communication link between the seismic spread and the central controller; forming a communication link between at least one source encoder and the seismic spread; forming a wireless communication link between the at least one source encoder and at least one decoder; and controlling the at least one remote encoder from the central controller, wherein the central controller instructs the at least one source encoder to transmit the signal to the source decoder.

Examples of certain features of the systems, methods and apparatus disclosed herein have been summarized rather broadly in order that detailed description thereof that follows may be better understood, and in order that the contributions to the art may be appreciated. There are, of course, additional features of the disclosure that will be described hereinafter and will form the subject of the disclosure. The summary provided herein is not intended to limit the scope.

### BRIEF DESCRIPTION OF THE DRAWINGS

The novel features of this disclosure, as well as the disclosure itself, will be best understood from the attached drawings, taken along with the following description, in which similar reference characters generally refer to similar elements, and in which:

FIG. 1 shows a cable seismic data acquisition system made in accordance with one embodiment of the present disclosure;

FIG. 2 is a representation of a wireless seismic data acquisition system made in accordance with one embodiment of the present disclosure;

FIG. 3 shows a source encoder arrangement in accordance with one embodiment of the present disclosure; and

FIG. 4 shows a configurable encoder according to one embodiment of the present disclosure.

### DETAILED DESCRIPTION OF THE EMBODIMENTS

The present disclosure relates to devices and methods for controlling activities relating to seismic data acquisition. The present disclosure may be implemented in embodiments of different forms. The drawings shown and the descriptions provided herein correspond to certain specific embodiments of the present disclosure for the purposes of explanation of the concepts contained in the disclosure with the understanding that the present disclosure is to be considered an exemplification of the principles of the disclosure, and is not intended to limit the scope of the disclosure to the illustrated drawings and the description herein.

FIGS. 1 and 2 depict illustrative, but not exclusive, seismic data acquisition systems that may implement the methods of the present disclosure. The basic components of these systems are discussed in greater detail below. Thereafter, the methods for enabling communication for these systems are described.

FIG. 1 depicts a conventional cable seismic data acquisition system 100 that may implement certain methods of the present disclosure. The system 100 uses a seismic spread 101 that includes seismic devices such as seismic sensor units 102 and battery boosters. Each string of sensors is typically coupled via cabling to a data acquisition device 103, and several of the data acquisition devices and associated string of sensors are coupled via cabling 110 to form a line 108, which is then coupled via cabling 112 to a line tap or (crossline unit) 104. Several crossline units 104 and associated lines are usually coupled together by cabling, such as shown by the dotted line 114. The sensors 102 are usually spaced between 10-50 meters. Each of the crossline units 104 typically performs some signal processing and then stores the processed signals as seismic information. The crossline units 104 are each typically coupled, either in parallel or in series, with one of the units 104a serving as an interface between a central controller, which may be a central recording system (CRS) 106, and all crossline units 104. This system may use wired communication media, e.g., RS232, Ethernet, RS485, USB, etc. During seismic operations, the CRS 106 includes data processing devices and communication device for transmitting control signals to the seismic spread 101 and receiving seismic information from the seismic spread 101, this seismic information may be recorded. For example, the sensors 102 may send signals representative of measured seismic energy to the CRS 106 and the CRS 106 may record this seismic information in real-time or near real time. This system is considered a cable system because a majority of the transmissions are made using physical conductors (e.g., wire). As used herein, a “control signal” is a command to a machine to perform, not perform, or stop performing one or more tasks. The “control signal” is in a form that can be received and understood by such a machine.

In an active mode, the system 100 uses one or more seismic energy sources 206 to generate seismic energy of known characteristics, such as magnitude, frequency etc., at known locations in the seismic spread to impart seismic energy into the subterranean formation. Illustrative energy sources include impulsive sources such as explosive sources. Illustrative impulsive sources include, but are not limited to dynamite and compressed gas source. Another illustrative energy source is a vibrator truck. Vibrator trucks support a heavy base plate that is connected to an inertia mass. The inertia mass contains a linear actuator that reciprocates the base plate along a vertical or horizontal axis in reaction to the momentum of the inertia mass. The reciprocating base plate injects a vibratory wave train into the earth. A programmable controller controls the force and frequency of the signal generated by the inertia mass. Still another energy source is an accelerated weight-drop truck. A weight-drop truck is a vehicle mounted ground impact which can used to provide the seismic source. A heavy weight is raised by a hoist at the back of the truck and dropped, possibly about three meters, to impact (or “thump”) the ground. It should be understood, however, that any device that generates usable seismic energy may be an energy source.

Referring to FIG. 2, a representation of a wireless seismic data acquisition system 200 that may implement the methods of the present disclosure. The system 200 includes a central controller, which may be a control unit (CU) 202, in data communication with each of a number of wireless field station units (FSU) or sensor stations 208 forming a seismic spread 201 for seismic data acquisition. The wireless communication between the central controller 202 with the FSUs may be direct bi-directional wireless communication or via an intermediate unit such as a repeater unit (RU)(not shown). Each sensor station 208 includes one or more sensors 212 for sensing seismic energy. The sensors 212 may be any suitable seismic sensors, including geophones, and one or more component accelerometers. The sensor stations 208 may include processors, memory, communication devices, and other electronics for acquiring and locally recording seismic data and communicating with the CU 202. The system may be considered wireless in that a majority of the signals are transmitted using wireless communication techniques.

Direct communication as used herein refers to individualized data flow as depicted in FIG. 2 by dashed arrows. A wireless communication system can be a VHF, UHF, WiFi, or other wireless radio communication system. The data flow can be bi-directional to allow one or more of: transmission of command and control instructions from the central controller 202 to each wireless sensor station 208; exchange of quality control and other data between the central controller 202 and each wireless sensor station 208; and transmission of status signals, operating conditions and/or selected pre-processed seismic information from each wireless sensor station 208 to the central controller 202. The communication might be in the form of radio signals transmitted from and received by the sensor stations 208 and central controller 202 via suitable antennas 203 and 204 respectively. As discussed above, the system 200 uses one or more seismic energy sources 206 to generate seismic energy of known characteristics, such as magnitude, frequency etc., at known locations in the seismic spread to impart seismic energy into the subterranean formation.

The central controller 202, the central station computer (CSC) 260 and a central server 280 exert control over the constituent components of the system 200 and direct activities of the operators and devices during the operation of the system 200. The server 280 can be programmed to manage data and activities over the span of the seismic surveying activities, which can include daily shooting sequences, updating the shots acquired, tracking shooting assets, storing seismic data, pre-processing seismic data and broadcasting corrections. CSC 260 may be integral with the CU 202. The central controller 202 also may act as a central radio unit. For large fields, radio antennas and repeater transceivers may also be deployed at selected field locations as described below.

Referring to FIGS. 1 and 2, in some situations, the systems 100, 200 may be deployed into a geographical area where reliable long distance radio communications are not possible between the central units and the sources (e.g., greater than two kilometers separates these devices). For these situations, the systems may include one or more source encoder systems 160 that use the seismic grid 101 or 201 to enable communications between the CRS 106 or CSC 260 and the sources 206.

Referring now to FIG. 3, there is shown one non-limiting embodiment of a source encoder system 160 that may be used with the cable-based system 100 of FIG. 1. In this arrangement, the CRS 106 (FIG. 1) can communicate with a source 206 using the source encoder system 160 and communication architecture of the seismic spread 101. Specifically, the source encoder system 160 may be connected via a physical data conductor, such as a cable 162, to the cabling 112. The cable 162 may be relatively short, e.g., ten meters. Also, in some embodiments a wireless connection may be used in lieu of the cable 162. That is, the source encoder system 160 may be used with the wireless system 200 of FIG. 2. In this arrangement, the CSC 260 (FIG. 2) can communicate with a source 206 using the source encoder system 160 and communication architecture of the seismic spread 201. The connection to the cabling may be at a “take out” 164 along the cabling 11.

In one arrangement, the source encoder system 160 provides a wireless communication link between the seismic spread 101 and the source 206. The source encoder system 160 may include a source encoder 166 and a remote source decoder 168. As used herein, the term encoder refers to a device that is configured to “encode” and transmit signals such as control signals. The term “decoder” refers to a device that is configured to “decode” a signal transmitted from an encoder. The source encoder 166 may include a processor 170 having a communication interface for communicating with the CSR 106 (FIG. 1). In wireless arrangements, the source encoder 166 may include a processor 170 having a communication interface for communicating with the CSC 260 (FIG. 2). The source encoder 166 may also include a wireless communication device 172 that can transmit and receive information encoded radio signals. The source decoder 168 may include a processor 176 and a wireless communication device 178 that can transmit and receive information encoded radio signals. The processor 176 may include a communication interface for communicating with the wireless communication device 172 and the source encoder 166. The processor 176 may also be configured to operate a source 206 (FIG. 1). Additionally, in some embodiments the source decoder 174 may include a position sensor 180 such as a global positioning device.

Referring to FIGS. 1, 2, and 3, in one mode of operation, personnel may wish to bring one or more sources to a ready-to-fire state. To do so, the CRS 106 of the system 100 may transmit a suitable control signal into the communication architecture of the seismic spread 101. In wireless arrangements, the CSC 260 of the system 200 may transmit a suitable control signal into the communication architecture of the seismic spread 201. The source encoders 166 receive the control signals and transmit an appropriate radio signal to the source decoders 168. Upon receipt of the control signal, the source decoder 168 takes a responsive action, e.g., bring the source 206 to a ready condition, fire the source 206, etc. The responsive action may also include transmitting to the source decoders 166 a status report, an operational condition (e.g., ready-to-fire), error conditions, etc.

Generally, it is desirable that the location of each of the source decoders 168 be uniquely identifiable. In one arrangement, a “source point flag number” may be associated with the location of each source decoder 168. The source point flag number may be derived or based on a preplanned seismic plan. This may be a value have alphabetical and/or numerical symbols. In one arrangement, the source decoder 168 may transmit a source point flag number to the source encoder 166 when requested or automatically. The source encoder 166 may transmit the source point flag number to the CRS 106 (FIG. 1) via the seismic spread 101 (FIG. 1). Alternatively or additionally, the position sensor 180 may determine the location coordinates of the source decoder 166. This location information may be solicited by the CRS 106 or sent automatically. In either case, the source decoder 168 can transmit the location determined by the position sensor 180 to the source encoder 166. The source encoder 166 re-transmits the source decoder location to the CRS 106 (FIG. 1) via the seismic spread 101 (FIG. 1). In one arrangement, the location information is sent only if the quality and accuracy of the position data of the source decoder 168 is not sufficient.

In wireless arrangements, the source encoder 166 may transmit the source point flag number to the CSC 260 (FIG. 2) via the seismic spread 201 (FIG. 2). Alternatively or additionally, the position sensor 180 may determine the location coordinates of the source decoder 166. This location information may be solicited by the CSC 260 or sent automatically. In either case, the source decoder 168 can transmit the location determined by the position sensor 180 to the source encoder 166. The source encoder 166 re-transmits the source decoder location to the CSC 260 (FIG. 2) via the seismic spread 201 (FIG. 2).

It should be appreciated that embodiments of the present disclosure enable the CRS 106 to communicate with source decoders 166 using a combination of wired cables in the seismic spread 101 and the radio signals exchanged by the source encoders 166 and source decoders 168. Therefore, even if direct radio communications may not be possible between the CRS 106 and the sources 206, the CRS 106 can use the seismic spread 101 to operate the seismic sensors 102, receiving seismic information from the seismic sensors 102, communicate with the source decoders 168, and control the sources 206. During these operations, the source encoders 166 may be energized using the power supply associated with the seismic spread 101.

The FIG. 3 system 300 may also be used with the wireless system 200 of FIG. 2. Referring to FIGS. 2 and 3, the source encoder system 160 may be connected via a physical data conductor, such as a cable 162, to a sensor station 208. The cable 162 may be relatively short, e.g., ten meters. Also, in some embodiments a wireless connection may be used in lieu of the cable 162. This connection enables the CSC 260 to communicate with source decoders 166 using the wireless communication system of the seismic spread 201 (FIG. 2) and the radio signals exchanged by the source encoders 166 and source decoders 168. Therefore, even if direct radio communications may not be possible between the CSC 260 and the sources 206, the CSC 260 can use the seismic spread 201 to operate the seismic sensors 208, receiving seismic information from the seismic sensors 208, communicate with the source decoders 168, and control the sources 206. In embodiments where the CSC 260 does not receive seismic data from the sensor stations 208 as it is being detected, this information is stored locally at the sensor stations 208 (FIG. 2).

Referring now to FIG. 4, there is shown another embodiment of a source encoder system 300. The source encoder system 300 may be connected via a physical data conductor or wireless to a seismic spread 101 (FIG. 1) or seismic spread 201 (FIG. 2) as described previously. In one arrangement, the source encoder system 300 may include an in-field configurable source encoder 320 and an in-field configurable source decoder 340. The term “configurable” refers to the functionality that the encoder can be reconfigured to work as a decoder and the decoder can be reconfigured to work as an encoder. The devices may be configured manually or via suitable electronic commands.

The source encoder 320 may include a processor 322 having a communication interface for communicating with the CSR 106 (FIG. 2) or CU 260 (FIG. 2). The source encoder 322 may also include a wireless communication device 324 that can transmit and receive information encoded radio signals. The processor 322 may also be configured to operate a source 326, which may be a source 206 (FIG. 1). Additionally, in some embodiments the source encoder 322 may include a position sensor 180 such as a global positioning device.

The source decoder 340 may include a processor 342 having a communication interface for communicating with the CSR 106 (FIG. 2) or CU 260 (FIG. 2). The source decoder 342 may also include a wireless communication device 344 that can transmit and receive information encoded radio signals. The source decoder 340 may include a wireless communication device 344 that can transmit and receive information encoded radio signals. Additionally, in some embodiments the source decoder 340 may include a position sensor 180 such as a global positioning device. The processor 342 may also be configured to operate a source 346, which may be a source 206 (FIG. 1).

The source encoder 320 and the source decoder 340 are configurable in that either device can transmit control signals to the other device. Specifically, the source encoder 320 can control the source decoder 340 in order to operate the source 346. After both devices have been reconfigured, the source encoder 340 can control the source decoder 320 in order to operate the source 326.

In one mode of operation, personnel may wish to bring the source 346 to a ready to fire state. To do so, the CRS 106 (FIG. 1) of the system 100 (FIG. 1) may transmit a suitable control signal into the seismic spread 101 (FIG. 1). The source encoder 320 receives the control signals and transmits an appropriate radio signal to the source decoder 340. Upon receipt of the control signal, the source decoder 340 takes a responsive action, e.g., bring the source 346 (FIG. 1). Afterwards, personnel may wish to bring the source 326 to a ready to fire state. To do so, personnel may physically reconfigure the source encoder 320 to operate as a decoder and reconfigure the source decoder 340 to operate as an encoder. Thereafter, the CRS 106 (FIG. 1) of the system 100 (FIG. 1) may transmit a suitable control signal into the seismic spread 101 (FIG. 1). The now-source encoder 340 receives the control signals and transmits an appropriate radio signal to the now-source decoder 320. Upon receipt of the control signal, the now source decoder 320 takes a responsive action, e.g., bring the source 326 (FIG. 1).

The term “seismic devices” means any device that is used in a seismic spread, including, but not limited to sensors, sensor stations, receivers, transmitters, power supplies, control units, etc. As used above, a seismic spread is a network of equipment configured to detect seismic energy. As used above, a central controller is a device used to control the seismic spread. The disclosure herein is provided in reference to particular embodiments and processes to illustrate the concepts and methods. Such particular embodiments and processes are not intended to limit the scope of the disclosure or the claims. All such modifications within the scope of the claims and disclaimers are intended to be part of this disclosure.

What is claimed is:

1. A system for acquiring seismic information, comprising:
a central controller;
a seismic spread in signal communication with the central controller;
at least one source encoder in signal communication with the seismic spread; and
at least one source decoder in wireless signal communication with the at least one source encoder,
wherein the at least one source decoder and the at least one source encoder are each selectively responsive to a control signal, and wherein the at least one source decoder and the at least one source encoder are selectively configured to transmit the control signal.

2. The system of claim 1, wherein:
the seismic spread includes a plurality of seismic devices configured for wireless signal communication; and
the at least one source encoder is in signal communication with at least one of the plurality of seismic devices.

3. The system of claim 2, wherein the seismic spread includes at least one of: (i) a line tap, (ii) a battery booster, (iii) a seismic receiver, and (iv) a take out.

4. The system of claim 3, wherein the seismic spread further comprises a communication interface using one of: (i) a wired signal carrier, and (ii) wireless signals.

5. The system of claim 4, wherein the at least one source encoder is in signal communication with at least one of the plurality of seismic devices, wherein the central controller is configured to communicate commands and data messages and signals with the at least one source encoder using the communication interface.

6. The system of claim 1, wherein:
the central controller has a central recording system (CRS); and
the seismic spread includes at least one cable in signal communication with the CRS and a plurality of seismic devices being disposed along the at least one cable, wherein the at least one source encoder in signal communication with the at least one cable.

7. The system of claim 1, wherein the at least one source encoder and the at least one source decoder communicate using radio signals.

8. The system of claim 1, further comprising:
a position sensor associated with the source encoder, wherein the central controller estimates a location of the source encoder using the position sensor;
wherein the at least one source decoder transmits a location determined by the position sensor to the at least one source encoder;
wherein the at least one source encoder transmits the at least one source decoder location to the central controller via the seismic spread;
wherein the seismic spread energizes the source encoder;
wherein the at least one source encoder includes a plurality of source encoders distributed along at least one cable; and
wherein the at least one source decoder includes a plurality of source decoders.

9. The system of claim 1, wherein the at least one source encoder and the at least one source decoder communicate using one of: (i) a signal carrying cable connecting the at least one source encoder and the at least one source decoder communication; and (ii) wireless signal transmissions.

10. The system of claim 1, wherein the at least one source decoder transmits its operational state to the at least one source encoder, and wherein the at least one source encoder transmits the at least one source decoder operational state to the central controller via the seismic spread.

11. The system of claim 1, wherein the at least one source decoder transmits a Source Point Flag Number to the at least one source encoder, and wherein the at least one source encoder transmits the Source Point Flag Number to the central encoder via the seismic spread.

12. A method for acquiring seismic information, comprising:
positioning a central controller and a seismic spread in a geographical area of interest;
forming a communication link between the seismic spread and the central controller;
forming a communication link between at least one source encoder and the seismic spread;
forming a wireless communication link between the at least one source encoder and at least one decoder; and
controlling the at least one source encoder from the central controller, wherein the central controller instructs the at least one source encoder to transmit the signal to the source decoder.

13. The method of claim 12, further comprising:
controlling the at least one source decoder using a control signal sent from the at least one source encoder;
configuring the at least one source decoder to send a second control signal after sending the control signal;
configuring the at least one source encoder to be responsive to the second control signal after sending the control signal; and
controlling the at least one source encoder using a control signal sent from the at least one source decoder.

14. The method of claim 12, wherein:
the seismic spread has a plurality of seismic devices configured for wireless communication; and
the at least one source encoder is in signal communication with at least one of the plurality of seismic devices.

15. The method of claim 12, wherein:
the central controller has a central recording system (CRS); and
the seismic spread includes at least one cable in signal communication with the CRS, and a plurality of seismic devices disposed along the at least one cable.
